(19) United States
(12) Patent Application Publication
(10) Pub. No.: US 2025/0076886 A1
(43) Pub. Date: Mar. 6, 2025

(54) METHOD FOR SEARCHING TARGET WALL BY POOL CLEANING ROBOT AND DEVICE

(71) Applicant: Shenzhen Aiper Intelligent Co., Ltd., Shenzhen (CN)

(72) Inventor: Qi HUANG, Shenzhen (CN)

(73) Assignee: Shenzhen Aiper Intelligent Co., Ltd., Shenzhen (CN)

(21) Appl. No.: 18/949,785

(22) Filed: Nov. 15, 2024

(30) Foreign Application Priority Data
Sep. 5, 2024 (CN) 2024112439723

(51) Int. Cl. B25J 9/16; B25J 11/00; E04H 4/16

(52) U.S. Cl. CPC B25J 9/1664; B25J 9/1653; B25J 9/1661; B25J 11/0085; E04H 4/1654

(57) ABSTRACT

The present disclosure relates to the technical field of swimming pool cleaning, and more specifically, to a method for searching a position for wall climbing underwater by a pool cleaning robot. The method comprises: the swimming pool cleaning robot rotates one circle underwater to obtain data of the perimeter of a swimming pool; it is determined whether the cleaning robot is now facing a wall in its current orientation based on the perimeter data; if not, a wall closest to the swimming pool cleaning robot is selected from the perimeter data and the robot is controlled to rotate to directly face the closest wall. In the end, the robot is controlled to move towards the closest wall. According to the present disclosure, in case that the robot needs to climb a wall for wall cleaning or go ashore, the robot can rapidly climb the wall.

### FIELD OF THE INVENTION

The present disclosure relates to the technical field of swimming pool cleaning, and more specifically, to a method for searching a target wall by a pool cleaning robot, and a pool cleaning robot.

### BACKGROUND OF THE INVENTION

With development of technology, demands for pool cleaning equipment are continuously increasing. Pool cleaning equipment refers to equipment for cleaning pools, swimming pools or hydrotherapy pools. Specifically, the pool cleaning equipment may be swimming pool robot with highly intelligent motion and operation capabilities. For existing swimming pool cleaning robot, after a pool bottom is cleaned, if it is required to continue cleaning walls, the robot may randomly select a direction to move forward or directly move forward along the current direction until it hits a wall. Then, the robot climbs the wall. However, if the wall is far away, the robot may travel a long distance, thereby wasting time.

### SUMMARY OF THE INVENTION

With respect to the above issues in the prior art, an object of the present disclosure is to find the most time-saving path to the wall by collecting and processing wall data.

To address the above issues, the present disclosure provides a method for searching a target wall by a pool cleaning robot, the method comprising:
obtaining a wall climbing instruction;
controlling a pool cleaning robot to rotate by a preset angle at a pool bottom, so as to collect wall data of a pool during rotation;
selecting a target wall based on the wall data;
controlling the cleaning robot to move towards the target wall;
wherein the target wall includes a wall facing a current orientation of the pool cleaning robot or a wall closest to the pool cleaning robot.

Preferably, when the target wall includes the wall closest to the pool cleaning robot, the cleaning robot is controlled to rotate to face the closest wall and to move towards the closest wall.

Preferably, when the target wall includes a wall facing the current orientation of the pool cleaning robot, the cleaning robot is controlled to move along current orientation towards the target wall.

Preferably, the preset angle is greater than or equal to 360 degrees.

Preferably, the rotation includes at least one rotation and if the target wall includes a wall facing the current orientation of the pool cleaning robot, next rotation is not performed.

Preferably, when the wall closest to the pool cleaning robot includes a plurality of walls, a first wall collected or a wall that requires the cleaning robot to rotate by a minimum angle serves as a target wall.

Preferably, the step of selecting a target wall based on the wall data includes fitting collected wall data and judging whether a fitted straight line segment or curved segment of wall is perpendicular to the orientation of the robot; if yes, a corresponding wall serves as the wall facing the current orientation of the pool cleaning robot.

Preferably, the step of selecting a target wall based on the wall data includes fitting collected wall data and judging whether a fitted straight line segment or curved segment of wall is closest to the robot; if yes, a corresponding wall serves as a wall closest to the pool cleaning robot.

Preferably, the current orientation of the pool cleaning robot and a rotation angle by which the robot rotates to face the closest wall are both generated based on IMU or gyroscope data.

Preferably, the wall climbing instruction is generated by a user or automatically generated by a robot based on progression of a cleaning operation or the robot's own state.

Further, the present disclosure also provides a pool cleaning robot which can execute the above method for searching a target wall.

The method for searching a target wall according to the present disclosure achieves following advantageous effects:

By controlling the sensor mounted on the robot to collect data of the swimming pool edge and processing the edge data, the most time-saving path to the target wall is identified. Accordingly, the robot may be controlled to move towards the target wall. For example, when the closest wall serves as the target wall, the robot travels a short range to the wall, thereby saving time. Alternatively, when the wall facing the current orientation of the robot serves as the target wall, the robot may directly move forward without turning, to arrive at the edge of the swimming pool. The time for turning is saved.

### BRIEF DESCRIPTION OF THE DRAWINGS

To more clearly explain the technical solution of the present disclosure, drawings to be used in the description of the embodiments or the prior art are to be briefly introduced. Apparently, the drawings described below merely involve some embodiments of the present disclosure. Other drawings may also be obtained by those ordinary skilled in the art based on the provided drawings without requiring any exercises of inventive work.

FIG. 1 illustrates a flowchart of searching a target wall by a pool cleaning robot according to embodiments of the present disclosure.

### DETAILED DESCRIPTION OF THE PREFERRED EMBODIMENTS

With reference to the drawings in the embodiments of the present disclosure, the technical solution in the embodiments of the present disclosure is clearly and completely described below. Obviously, the described embodiments are part of the embodiments of the present disclosure, rather than all of them. All other embodiments obtained by those ordinary skilled in the art based on the embodiments in the present disclosure without requiring any exercises of inventive work fall within the protection scope of the present disclosure.

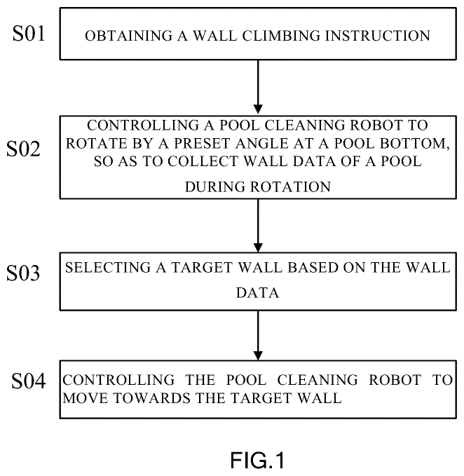

FIG. 1 illustrates a method for searching a target wall by a pool cleaning robot provided by the embodiments of the present disclosure. The method comprises:

S01: the robot obtains a wall climbing instruction. The wall climbing instruction is generated by a user, or automatically produced by the robot based on progress of a cleaning operation or the robot's own state. For example, the user may issue an instruction via a remote control to manipulate the robot to switch from a pool bottom cleaning mode to a wall or waterline cleaning mode, or from the pool bottom cleaning operation state to a state in which the robot finishes the task and goes ashore; after finishing the pool bottom cleaning operation task, the robot also may automatically generate a control command and switch from the pool bottom cleaning mode to the wall cleaning or waterline cleaning mode; alternatively, the robot may generate an instruction by monitoring its own failure or low battery, to trigger wall climbing act to leave the pool bottom; therefore, the robot goes ashore for battery charging or maintenance.

S02: after obtaining the instruction, the robot rotates by a preset angle at the pool bottom, e.g., one circle or nearly one circle. The robot collects data of the walls of the pool during the rotation. Sensors for collecting data include ultrasonic sensor, DTOF sensor, camera or radar. These sensors may collect point cloud data of a target object, the point cloud data including distance information.

S03: a target wall is selected based on the wall data. Specifically, the wall data includes point cloud data of the perimeter of the swimming pool or pool. A straight line fitting or a curve fitting is performed on the point cloud data, and the fitted straight line segment or curved segment represents the wall. Since the IMU would output attitude or direction information of the corresponding robot while the sensor is collecting the data, a position relation between the robot and the wall being fitted may be determined based on the IMU data.

In view of the position relation, a wall facing the current orientation of the pool cleaning robot is determined, i.e., the wall that the head of the robot directly faces after the rotation. The wall serves as the target wall. The robot may continue to move directly towards the target wall without turning, which saves time and the step of changing the motion state. Here, the face expression may be appreciated as the straight line segment being perpendicular to the orientation of the robot or a tangent line of the curved segment being perpendicular to the orientation of the robot. Being perpendicular may certainly be understood as being substantially perpendicular, and slight deviations are also acceptable.

Besides, the wall closest to the pool cleaning robot may also be determined as the target wall based on the position relation. The shortest distance between the position where the robot is located and the fitted straight line segment or curved segment of the wall is the distance between the robot and the wall.

Whether it is the wall closest to the robot or the wall facing the current orientation of the robot, the movement time or the movement distance is saved. As such, the two walls may be configured to be a primary option and a secondary option. Either of them may be selected. Usually the wall facing the current orientation of the robot would be the primary option. In case that there lacks a wall facing the current orientation of the robot, the wall closest to the robot is selected as the target wall, to minimize the robot's movement changes and bring a satisfactory experience to the user.

S04: the cleaning robot is controlled to move towards the target wall. If the target wall is the wall facing the current orientation of the robot, the robot is controlled to continue to move along the current orientation and may arrive at the wall without turning; if the target wall is the wall closest to the robot and the robot does not face towards the target wall or the head of the robot is not facing the target wall, it is required to control the robot to turn to face the target wall. Then, the cleaning robot is controlled to move towards the closest wall. An angle between the orientation of the robot and the fitted line segment of the wall may be calculated based on the data output by the IMU and this angle is the angle by which the robot is required to rotate.

Further, in the step S02, the preset angle is equal to 360 degrees or slightly greater than or smaller than the 360 degree. The preset angle may also be set to other degrees as long as sufficient walls can be collected. Generally, if the starting position of the robot before rotation is exactly opposite to the wall, then the head of the robot just faces the wall after the rotation by one circle, and the robot may directly move towards the wall.

The robot may be controlled to make one or more rotations. For example, if it is determined that the collected data are of poor quality or the target wall is not obtained after rotating one circle, the robot may rotate repeatedly. Once the target wall is obtained, the robot may stop performing the next rotation.

Under special circumstances, if there are multiple walls closest to the pool cleaning robot, the first wall collected or the wall that requires the cleaning robot to rotate by a minimum angle serves as the target wall.

The swimming pool cleaning robot moves forward at the bottom of the pool and does not start executing the wall climbing act until it arrives at the wall or hits the wall. The forward path at the pool bottom may include straight line movement and detours.

Embodiments of the present disclosure also provide a cleaning robot, which can load programs to implement the above method for searching a target wall.

Detailed implementations of the present disclosure have been sufficiently disclosed above. It is to be indicated that any changes to the detailed implementations by those skilled in the art do not deviate from the scope of the claims of the present disclosure. Correspondingly, the scope of the claims of the present disclosure is not restricted to the aforementioned detailed implementations.

I/we claim:

1. A method for searching a target wall by a pool cleaning robot, characterized in that, the method comprises:
obtaining a wall climbing instruction;
controlling a pool cleaning robot to rotate by a preset angle at a pool bottom, so as to collect wall data of a pool during rotation;
selecting a target wall based on the wall data; and
controlling the pool cleaning robot to move towards the target wall;
wherein the target wall includes a wall facing a current orientation of the pool cleaning robot or a wall closest to the pool cleaning robot.

2. The method of claim 1, wherein when the target wall includes the wall closest to the pool cleaning robot, the pool cleaning robot is controlled to rotate to face the closest wall and to move towards the closest wall.

3. The method of claim 1, wherein when the target wall includes a wall facing the current orientation of the pool cleaning robot, the pool cleaning robot is controlled to move along current orientation towards the target wall.

4. The method of claim 1, wherein the preset angle is greater than or equal to 360 degrees.

5. The method of claim 1, wherein the rotation includes at least one rotation and if the target wall includes a wall facing the current orientation of the pool cleaning robot, a next rotation is not performed.

6. The method of claim 4, wherein when the wall closest to the pool cleaning robot includes a plurality of walls, a first wall collected or a wall that requires the pool cleaning robot to rotate by a minimum angle serves as a target wall.

7. The method of claim 1, wherein the step of selecting a target wall based on the wall data includes fitting collected wall data and judging whether a fitted straight line segment or curved segment of wall faces the orientation of the pool cleaning robot; if yes, a corresponding wall serves as the wall facing the current orientation of the pool cleaning robot.

8. The method of claim 1, wherein the step of selecting a target wall based on the wall data includes fitting collected wall data and judging whether a fitted straight line segment or curved segment of wall is closest to the pool cleaning robot; if yes, a corresponding wall serves as a wall closest to the pool cleaning robot.

9. The method of claim 2, wherein the current orientation of the pool cleaning robot and a rotation angle by which the pool cleaning robot rotates to face the closest wall are both generated based on IMU or gyroscope data.

10. The method of claim 1, wherein the wall climbing instruction is generated by a user or automatically generated by a robot based on progress of a cleaning operation or the pool cleaning robot's own state.

11. A pool cleaning robot, which can execute the method for searching a target wall according to claim 1.
